(19) United States
(12) Patent Application Publication
(10) Pub. No.: US 2005/0035711 A1
(43) Pub. Date: Feb. 17, 2005

(54) Method and apparatus for a high efficiency ultraviolet radiation source

(75) Inventors: Rick B. Spielman, Tijeras, NM (US); Michael L. Fraim, Corrales, NM (US); Joseph A. Mervini, Albuquerque, NM (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ABQ Ultraviolet Pollution Solutions, Inc.

(21) Appl. No.: 10/855,461

(22) Filed: May 27, 2004

Related U.S. Application Data
(60) Provisional application No. 60/473,750, filed on May 27, 2003.

(51) Int. Cl. H01J 17/00; H01J 17/20; H01J 61/00

(52) U.S. Cl. 313/567; 313/637

(57) ABSTRACT

An efficient, intense ultraviolet radiation source is disclosed that uses electrodes, external to the UV-generating plasma, to eliminate electrode erosion. High-frequency electrical energy is coupled to the UV-emitting plasma capacitively. The electrodes are attached to the glass envelope in such a way as to minimize or eliminate resistive or capacitive losses. The intense ultraviolet radiation source can be generated by applying a continuous or pulsed/gated high-frequency voltage to the glass envelope via the external electrodes. Electrode erosion is eliminated as a reason for lamp failure and the peak intensity that can be generated without damage is greatly increased.

### FIELD OF THE INVENTION

This invention relates generally to the field of ultraviolet radiation sources, and more particularly to efficient ultraviolet radiation sources generating wavelengths less than 254 nm. The improved efficiency allows economical use of ultraviolet sources for a wide range of applications. A method and apparatus for such ultraviolet radiation sources is disclosed.

### BACKGROUND OF THE INVENTION

Ultraviolet radiation (UV) is the electromagnetic radiation having wavelengths between that of x rays and visible light, with wavelengths of about 100 nanometers (nm) to about 400 nm. Ultraviolet radiation can be further divided into spectral bands: UV-A, having wavelengths in the range of about 320 nm to about 400 nm, UV-B, having wavelengths of about 290 nm to about 320 nm, and UV-C, having wavelengths between about 290 nm and about 180 nm. The shorter the wavelength of the ultraviolet radiation, the higher the photon energy, and the more useful the radiation is for photochemical applications. A number of important uses for ultraviolet radiation have been found. These uses have driven the development of ultraviolet radiation sources that produce the desired wavelengths for the particular applications. For example, ultraviolet light with wavelengths of about 254 nm has been used as a germicidal aid in purifying wastewater as these wavelengths of UV can kill or alter the genetic material of certain organisms rendering them unable to reproduce, and thus suppressing microorganism growth. Other applications of short wavelength ultraviolet radiation include the generation of ozone, the dissociation of total organic content (TOC) in water or on surfaces, and the dissociation of pollutants such as VOCs (Volatile Organic Compounds) and TAPs (Toxic Air Pollutants).

Commercial ultraviolet radiation sources require a unique mixes of rare gases, such as mercury vapor, xenon, deuterium, or krypton to generate the required UV spectrum. Additionally, UV sources generating radiation with wavelengths shorter than 254 nm suffer from reduced efficiency and increased cost. The reduced efficiency is reflected by heating of the UV-transmitting envelope surrounding the source. As these envelopes (typically sapphire or quartz) absorb energy they become heated, which in turn causes an increase in the absorption coefficient of the envelope. If the external cooling cannot keep up with the heating, the envelope will fail. Most UV-C bulb's outputs are limited to ˜40 W per meter length.

Another drawback to current UV generating systems is that the UV sources or bulbs have a short lifetime. As the electrodes wear, the inner surface of the envelope is coated by eroded electrode material, the gases become contaminated, and the efficiency of the source decreases until replacement is required. The cost of bulb replacement can be significant for high power applications.

### DISCUSSION OF PRIOR ART

Prior art in the field of ultraviolet radiation sources falls into several groupings, including low-pressure mercury vapor discharge, low-pressure rare gas discharge, high-pressure discharge in sodium (mercury and rare gases), electrode-less lamps driven by radio frequency induction and microwaves, thermal emitters, and pulsed plasma sources. Most of these disclosures relate to ultraviolet radiation sources that emit UV continuously in time.

A low-pressure mercury discharge is the standard source of low-intensity UV-A and UV-B ultraviolet radiation. Several disclosures relate to the development of low-pressure sources, their optimization, and methods for applying these sources to numerous applications. For example, U.S. Pat. No. 4,237,401 issued to Couwenberg and entitled “Low-Pressure Mercury Vapor Discharge Lamp,” describes the optimization of low-pressure mercury vapor lamps for UV generation. U.S. Pat. No. 4,349,765 issued to Brandli and entitled “Ultraviolet Generating Device Comprising Discharge Tube Joined to Two Tubular Envelopes” discloses UV generation in which the output is optimized by the addition of rare gases to the mercury vapor. U.S. Pat. No. 6,387,115 issued to Smolka et al. and entitled “Photodynamic Cylindrical Lamp with Asymmetrically Located Electrodes and Its Use” discloses a low-pressure, high-power UV source with a UV transmissive glass envelope. The disclosures of each these references are herein incorporated by reference to the extent that they are not inconsistent with this application.

Several disclosures discuss the use of low-pressure rare gas discharges, such as xenon and argon rather than mercury, to generate UV radiation. These gases are selected to improve the source efficiency and to remove the mercury environmental hazard from the UV lamp. For example, U.S. Pat. No. 3,970,856 issued to Mahaffey et al. and entitled “Ultraviolet Light Application” discloses the development of hand-held argon discharge UV lamps. U.S. Pat. No. 4,550,275 issued to O'Loughlin and entitled “High Efficiency Pulse Ultraviolet Light Source” discloses the use of xenon in increasing the efficiency of a low pressure UV source. The disclosures of each these references are herein incorporated by reference to the extent that they are not inconsistent with this application.

Yet other disclosures relate to the use of high-pressure lamps for the generation of visible light for area lighting that can be tuned to generate ultraviolet light. See, for example, U.S. Pat. No. 4,112,335 issued to Gonser et al. and entitled “Rapid Pulse Ultraviolet Light Apparatus” in which high-pressure xenon is used to generate an intense pulsed UV source. U.S. Pat. No. 5,905,341 issued to Ikeuchi et al. and entitled “High Pressure Mercury Ultraviolet Lamp” describes a similar lamp using high-pressure mercury rather than xenon to generate ultraviolet radiation. The high pressure of these lamps requires a relatively thick strong envelope, thereby absorbing a fraction of the short wavelength UV that is generated by the lamp. The disclosures of each these references are herein incorporated by reference to the extent that they are not inconsistent with this application.

Yet other sources disclose the use of low-pressure lamps that do not involve the use of metallic electrodes, and thereby increasing the lifetime of the lamps. Because the erosion of electrodes and the re-deposition of electrode material on the glass envelope are serious lifetime issues, effort has been made to use radio-frequency electric fields or microwaves to drive the lamps. For example, U.S. Pat. No. 4,042,850 issued to Ury et al. and entitled “Microwave Generated Radiation Apparatus” describes the development of a microwave coupled plasma lamp. In addition, U.S. Pat. No. 6,265,835 issued to Parra entitled “Energy-Efficient Ultraviolet Source and Method” uses other high frequency sources to generate UV in an electrode-less lamp. The disclosures of each these references are herein incorporated by reference to the extent that they are not inconsistent with this application.

Other sources disclose that any object can emit UV radiation if its temperature is high enough. In U.S. Pat. No. 4,149,086 issued to Nath entitled “UV Irradiation Device”, a tungsten filament is heated to high temperatures as a UV source. The limitation is the rapid vaporization of the filament. However, this concept does not lead to temperatures high enough to generate significant quantities of UV-C radiation. The disclosure of this reference is herein incorporated by reference to the extent that it is not inconsistent with this application.

A number of disclosed UV radiation sources are based on pulsed plasmas. The UV source described in U.S. Pat. No. 3,978,341 issued to Hoell and entitled “Short Wavelength Ultraviolet Treatment of Polymeric Surfaces” uses a pulsed spark between two electrodes to generate ultraviolet radiation at 83.3 nm to 133.5 nm. The patent describes the method used to energize the spark, which involves a high temperature arc occurring in a low-pressure gas. The energy involved in this discharge is minimal. U.S. Pat. No. 5,945,790 issued to Schaefer and entitled “Surface Discharge Lamp” describes an electrical discharge that takes place over the surface of an insulating material. The material that makes up the discharge comes from the insulating material. The advantage of this configuration is the reproducible electrical discharge that takes place at a lower voltage per unit length of the distance between the electrodes. The presence of the insulating material in intimate contact with the discharge provides a limit on the peak current of the discharge. Finally, U.S. Pat. No. 6,031,241 issued to Silfvast et al. and entitled “Capillary Discharge Extreme Ultraviolet Lamp Source for EUV Microlithography and Other Related Applications” describes the use of capillary electrical discharges to generate high temperature plasmas and intense UV sources. Pulsed current is passed through a very small hole or capillary in an insulating material. The initial electrical discharge can be considered a surface discharge along the sides of the capillary hole. Material from the wall of the capillary erodes and compresses the discharge to the core of the capillary. The current heats the plasma to high temperatures and creates an efficient UV source. The practical limitation of this concept is that the UV radiation can only be extracted from the ends of the electrical discharge near one of the electrodes. The disclosures of each these references are herein incorporated by reference to the extent that they are not inconsistent with this application.

### SUMMARY OF THE INVENTION

An ultraviolet radiation (“UV”) source (or lamp) based on capacitively coupled, high-frequency or radiofrequency electric fields is disclosed that creates an efficient, intense UV output. The invention pertains to the method of creating and applying or bonding metallic electrodes to the external portion of the UV source envelope such that high-frequency electrical energy is efficiently coupled to the capacitance and resistance of the source. As used herein, an intense UV source is one that emits substantial amounts of high-energy, shorter wavelength UV as well as, possibly incidentally, wavelengths reaching into the visible and infrared spectrum, in comparison to typical UV sources known today. This method and apparatus allows for efficient production of UV radiation.

It is another object of the invention to provide a method and apparatus for producing intense UV output while eliminating substantially all electrode erosion.

It is yet another object of the invention to produce a long-lasting intense UV source, capable of producing >200 W of UV-C per meter length by substantially eliminating the effect of electrode erosion and electrode material redeposition on the transmission of UV through the transmitting envelope.

A UV source of the invention comprises two or more metallic electrodes that are affixed externally onto an electrically-insulated, UV-transmissive envelope or envelopes inside which is contained a UV-generating plasma. Preferably, the electrodes adhere intimately both mechanically and electrically to the insulating envelope of the UV source. Inside the envelope are gases or materials, or mixtures of gases or materials such as, but not limited to, hydrogen, deuterium, helium, neon, argon, krypton, xenon, bromine, chlorine, iodine, and/or mercury. Other suitable materials may be used as necessary to provide the desired UV wavelength in the output of the UV source. Source configurations include but are not limited to a dielectric barrier discharge (DBD) design or a classic plasma discharge tube.

The UV output may be readily varied by changing the frequency of the applied electric field, the applied voltage, and/or the waveform shape of the applied voltage. The source may be operated continuously or in a pulsed or gated mode if desired.

Finally, the overall efficiency of the UV source may be improved by material, material thickness, geometry, and/or the material application processes used for the electrodes and the insulating envelope.

### BRIEF DESCRIPTION OF THE DRAWINGS

The invention will be described with reference to the accompanying drawings in which like elements are referenced with like numerals.

FIG. 1 is a schematic of the electrode configuration.

FIG. 2 is a schematic depicting one UV source embodiment in dielectric barrier discharge configuration.

FIG. 3 is a schematic of an embodiment of a UV source in discharge tube configuration.

### DETAILED DESCRIPTION OF THE INVENTION

An efficient, intense UV source, according to the invention, includes a source of electrical energy (preferably though not exclusively having frequencies greater than 50 kHz), two or more electrodes (preferably though not exclusively metallic conductors), an electrically-insulated UV-transmissive envelope, and a gas comprised of one or more materials such as, but not limited to, hydrogen, deuterium, helium, neon, argon, krypton, xenon, bromine, chlorine, iodine, and/or mercury. Any other material or combination of materials may be used as necessary to provide the desired UV wavelength as output of the UV source.

The invention utilizes conducting metallic electrodes affixed to an insulating material, typically part of the UV-transmissive envelope of the UV source. High-dielectric constant materials may be advantageous in aiding the capacitive coupling of electrical energy. The conducting metallic electrodes are mounted, plated, coated, or otherwise intimately attached to the insulating material. The intimate nature of the attachment of the electrode to the insulator improves efficiency of the UV source, as poor contacts can result in large resistive losses. The process for the attachment of the electrode can be by any known method including but not limited to chemical or mechanical roughening of the insulator surface followed by mechanical attachment, chemical painting or bonding, electroplating, or vacuum deposition of the electrode material.

In one embodiment, one electrode is intimately affixed to all or substantially all of the entire inside surface of a glass tube such as Pyrex. As the fraction of the inside tube that is coated is decreased the overall efficiency of the UV output decreases. The inner tube can have an outer diameter in the range of about 0.5 cm to about 3 cm, preferably about 1.0 cm to 2.0 cm and most preferably about 1.25 cm. The inner tube can have a wall thickness in the range of about 0.5 mm to about 5 mm, preferably about 1.0 mm to 3.0 mm and most preferably about 2 mm. The thickness of the inner tube is determined by the requirement for mechanical strength and the need to have sufficient capacitance to couple the electrical energy to the UV source. The inner tube can have a length in the range of about 2.5 cm to about 60 cm, preferably about 10 cm to 30 cm and most preferably about 25 cm. The thickness of the electrode material is in the range of about 0.5 μm to about 500 μm, preferably about 1 μm to 10 μm and most preferably about 2 μm. The electrode material can be any good metallic conductor such as, but not limited to, copper, silver, aluminum, chrome, or stainless steel. The thickness of the electrodes is determined by the desire to minimize resistive losses and can be varied depending on the particular embodiment. A good contact between the electrode and the surface of the glass can eliminate electrical losses inherent in poor coupling (e.g. resistive losses from trapped gas breakdown or capacitive losses). A second electrode is similarly affixed to a fraction of the surface area of an insulated material that is part of the outer surface of a UV-transmissive envelope. The thickness of the outer electrode material is in the range of about 0.5 μm to about 500 μm, preferably about 1 μm to 10 μm and most preferably about 2 μm. The electrode material can be any good metallic conductor such as, but not limited to, copper, silver, aluminum, chrome, or stainless steel. The thickness of the electrodes is determined by the desire to minimize resistive losses and can be varied depending on the particular embodiment. The geometry of the outer electrode is preferably selected to minimize the blockage of UV by the electrode. Preferably, the effective transparency of the outer electrode to UV radiation is greater than 90%. The material of the outer envelope is chosen to minimize the absorption of UV by the glass and to reduce the impact of glass darkening or “solarization” caused by the long-term impact of UV on the glass. One exemplary material for use as the UV transmissive envelope is Suprasil™ (or Spectrosil™) manufactured by Heraeus, Phillips, and Saint-Gobain Quartz. There are numerous types of glasses, made by several manufacturers, having similar UV-transmitting properties. The outer diameter of the UV-transmitting tube (e.g. Suprasil™) is in the range of about 1 cm to about 5 cm, preferably about 1.5 cm to 4 cm and most preferably about 3.5 cm. The outer tube can have a wall thickness in the range of about 0.5 mm to about 5 mm, preferably about 1.0 mm to 4.0 mm and most preferably about 3 mm. The thickness of the inner tube is determined by the requirement for mechanical strength, the need to have sufficient capacitance to couple the electrical energy to the UV source, and the desire for high UV-transmission. The length of the outer tube should be comparable to the inner tube allowing one to join the inner and outer tubes. The volume between the inner and outer tube is filled with the desired gas. The gas is comprised of one or more materials such as, but not limited to, hydrogen, deuterium, helium, neon, argon, krypton, xenon, bromine, chlorine, iodine, and/or mercury. Any other material or combination of materials may be used as necessary to provide the desired UV wavelength as output of the UV source. The technique used to fill the UV source can be done by any conventional method known in the art. The pressure of the gas is in the range of about 300 Torr to about 1500 Torr, preferably about 500 Torr to 900 Torr and most preferably about 760 Torr. A voltage waveform having a shape ranging from sinusoidal to rapidly rising pulses, most preferably a rapidly rising square pulse, having frequencies ranging from 25 kHz to about 2 MHz, and preferably about 150 kHz and having a peak-to-peak magnitude of about 4 kV to about 12 kV, and preferably about 5 kV, is applied to the electrodes. An oscillating electric field is established between the two electrodes and passes through the inner and outer envelopes and the gas volume. The electric field should be of sufficient strength to break down the gas in numerous discharges, the density of discharges being typically proportional to the frequency of the applied voltage and the geometry of the tubes comprising the source. The UV efficiency is improved by a short rise time in the voltage pulse. The multitude of discharges effectively provides a resistive load between the capacitance of the glass envelope The overall electrical efficiency of this UV source is greatly enhanced by the intimate contact of the electrodes to the glass envelopes. This intimate contact also reduces the peak voltage required to operate the UV source and can reduce the heating of the two electrodes created by multiple, microscopic discharges between the electrodes (inner and outer) and the adjacent glass tube. The UV source, or lamp, begins emitting UV essentially instantaneously upon creation of the electric field. Typically, no reduction in lifetime of the lamp is caused by the startup of the UV source, or lamp.

Without wishing to be confined to any theory of operability, the UV source and associated electrical discharge can be configured in a number of ways and updated over a wide range of parameters with varying levels of efficiency.

In another embodiment, electrodes having a length in the range of about 0.25 cm to about 2 cm, preferably about 1 cm can be intimately affixed of the outside surface at both ends of a single glass tube. The tube diameter is in the range of about 4 mm to about 25 mm, preferably about 5 mm to 16 mm and most preferably about 12 mm. The tube wall has a thickness in the range of about 0.5 mm to about 5 mm, preferably about 1.0 mm to 4.0 mm and most preferably about 2 mm. The thickness of the inner tube is determined by the requirement for mechanical strength, the need to have sufficient capacitance to couple the electrical energy to the UV source, and the desire for high UV-transmission. The tube has a length in the range of about 15 cm to about 200 cm, preferably about 30 cm to 100 cm and most preferably about 75 cm. The thickness of the electrode material is in the range of about 0.5 μm to about 500 μm, preferably about 1 μm to 10 μm and most preferably about 2 μm. The electrode material can be any good metallic conductor such as, but not limited to, copper, silver, aluminum, chrome, or stainless steel. The thickness of the electrodes is determined by the desire to minimize resistive losses and can be varied depending on the particular embodiment. A good contact between the electrode and the surface of the glass eliminates electrical losses inherent in poor coupling (e.g. resistive losses from trapped gas breakdown or capacitive losses). The glass tube is chosen based on its UV absorption properties and desired performance specifications. The glass material is typically a high UV transmissive material, such as Suprasil™. The volume of the tube is filled with the desired gas. The gas is comprised of one or more materials such as, but not limited to, hydrogen, deuterium, helium, neon, argon, krypton, xenon, bromine, chlorine, iodine, and/or mercury. Any other material or combination of materials may be used as necessary to provide the desired UV wavelength as output of the UV source. The technique used to fill the UV source can be done by any conventional method known in the art. The pressure of the gas is in the range of about 1 Torr to about 50 Torr, preferably about 2 Torr to 15 Torr and most preferably about 5 Torr. A voltage waveform having, but not limited to, a sinusoidal shape, having frequencies ranging from 25 kHz to about 2 MHz, and preferably about 150 kHz and having a peak-to-peak magnitude of about 2 kV to about 8 kV, and preferably about 5 kV, is applied to the electrodes. An oscillating electric field is established between the two electrodes passing through the glass envelope and the gas volume in the tube.

The electric field should be sufficient to break down the gas in the form of a single diffuse electrical discharge. The optimum input voltage is determined by the desired UV power from the lamp and other mechanical limiting considerations such as glass tube temperature. The overall electrical efficiency of this UV source can be enhanced by the intimate contact of the electrodes to the glass envelope. The intimate contact reduces the peak voltage required to operate the UV source and can reduce the heating at the two electrode locations. The length of the tube is arbitrary, but longer tubes require higher voltages for comparable operation to observe similar UV output. Because there are no electrodes exposed to the plasma inside the tube, there is substantially no electrode erosion and no electrode limit on UV source, or lamp, lifetime. The UV source begins emitting UV substantially upon creation of the electric field. Typically, no reduction in lifetime of the lamp is caused by the startup of the operation of the lamp.

Without wishing to be confined to any theory of operability, the UV source and associated electrical discharge can be configured in a number of ways and operated over a wide range of parameters with varying levels of efficiency.

The output UV power (as measured by a calibrated UV photometer—Model UVX Radiometer manufactured by UVP) and the UV spectra (as measured by UV spectrometers—EPP2000 Fiber Optic Spectrometer manufactured by StellarNet Inc. and USB2000 manufactured by Ocean Optics Inc.) of the UV source can be varied in several different ways, according to the specific application. An average output power in the UV-C spectrum of greater than 50 W from a 50-cm long xenon-filled lamp in the first embodiment has been observed. Similarly, an average power in the UV-C spectrum of greater than 200 W from a 1.5-m long low-pressure neon/mercury lamp has been observed.

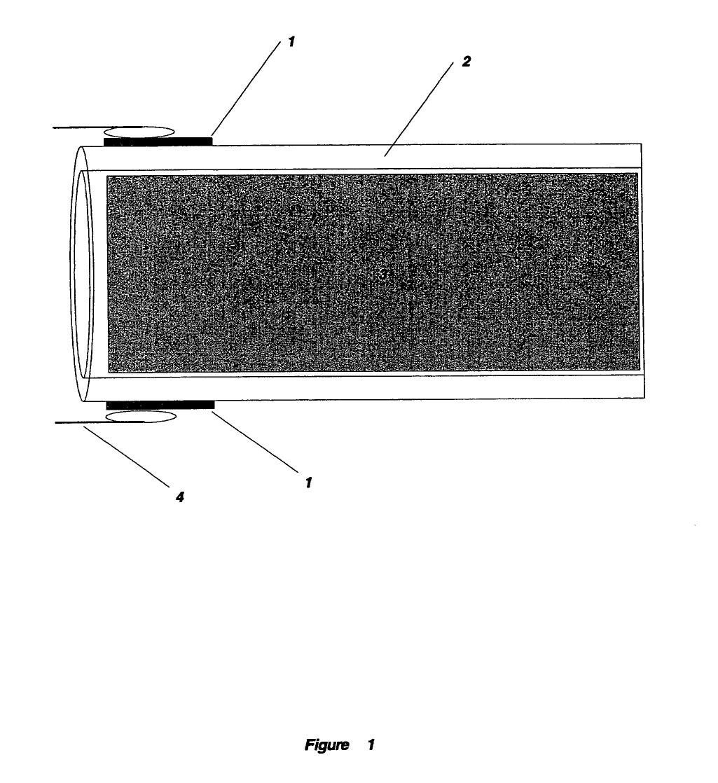

Turning now to the drawings, FIG. 1 shows one embodiment of the electrodes 1 attached to a glass tube, or envelope 2. As shown in this embodiment, the electrode 1 concentrically surrounds the glass tube 2 (although, as in the second embodiment described above one of the electrodes would be on the inside of a glass tube). The electrodes 1 are placed on the outside of the glass tube 2 such that they are physically separated from the heated plasma 3 and associated energetic ions or electrons. The attachment of the electrodes 1 to the glass tube 2 substantially eliminates gaps and pores in the contact. The electrical contact 4 to the electrodes 1 can be mechanical through compressive spring contact but numerous techniques such as, but not limited to, soldering and welding are possible. The thicknesses implied by the scale in FIG. 1 of the electrode 1 and glass tube 2 are for representation only and are not indicative of the actual or relative thicknesses.

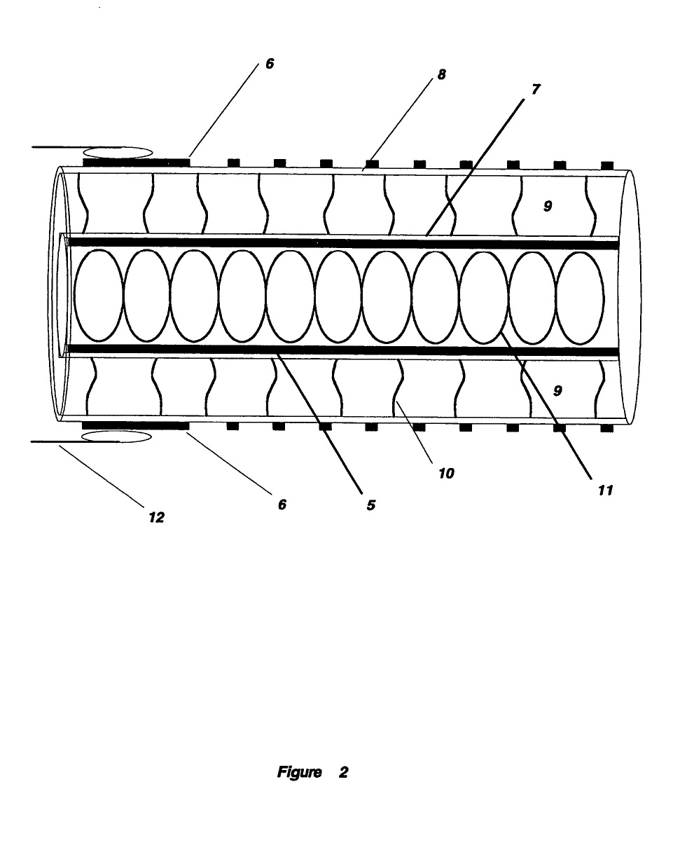

FIG. 2 shows one embodiment of the invention applied to a UV source in the DBD configuration comprising a metal electrode 5 covering the entire inner surface of an inner glass tube 7, and a metal electrode 6 in a mesh like configuration covering a small fraction of the outer surface area of an outer glass tube 8. The electrodes can be composed of any conductive metal but this embodiment uses nickel electrodes in order to minimize long-term oxidation. The electrode thickness in this embodiment is 2 μm. The electrodes 5 and 6 are applied to the inner and outer glass tubes 7 and 8 via bonding methods that result in an intimate contact preferably without voids. Typical methods for attaching the electrodes are chemical plating and vacuum depostion. Xenon gas 9 fills the annular void created between the outer wall of the inner glass tube 7 and the inner wall of the outer glass tube 8. The inner tube 7 is composed of Pyrex glass (although many types of glass will work equally well) and has an outer diameter of 1.5 cm and a thickness of 2 mm. The outer glass tube 8 is composed of UV-transmissive glass such as, but not limited to, Suprasil™. The outer tube 8 has an outer diameter of 3.0 cm and a thickness of 3 mm. Voltage can be applied to the inner electrode via a conductor 11 that extends the length of the inner tube 7 and contacts the inner electrode 5 using standard mechanical methods. The electrical connection to the outer electrode 6 is through a connector 12 at one end of the outer tube 7. Oscillating voltage applied between the inner electrode 5 and the outer electrode 6 may be continuous or gated. Multiple discharges 10 extend between the inner glass tube 7 and the outer glass tube 8 generating the UV radiation. Electrical energy is delivered to the discharges 10 via capacitive coupling from the inner electrode 5 and outer electrode 6 through the inner 7 and outer 8 glass tubes once voltage is applied to the electrodes 5 and 6.

The overall electrical behavior (voltage, current, and power) of the source configuration of FIG. 2 depends strongly on the geometry, gas fill pressure, frequency of the applied voltage, and the intimacy of the electrode contact with each glass tube. As described in the first embodiment, an applied voltage of 5 kV (peak to peak) having a frequency of 150 kHz has been observed to deliver a peak electrical power of ˜200 W to a UV source, or lamp, in the DBD configuration having the dimensions described. The efficiency of coupling to UV can also depend on the gas fill details (e.g., the gas or gases contained in the envelope and the pressure of that gas or gases).

For the conditions of 1 Bar (760 Torr) of substantially pure xenon the UV output of the UV source was observed to be >50 W in UV photons having a wavelength of about 172 nm.

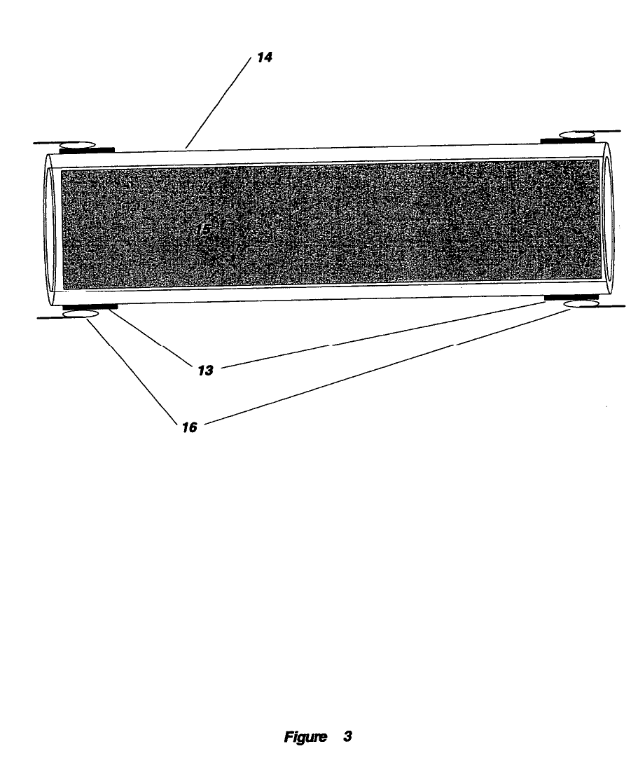

FIG. 3 depicts yet another embodiment comprising two metal electrodes 13 affixed to the outer surface of a single electrically-insulating glass tube 14 preferably near the ends of the tube. The length of the electrodes 13 is typically 1 cm. The length of the electrodes can be varied over a range from about 2 mm to about 2 cm depending on the coupling requirement and undesired coverage of the UV-emitting portion of the tube. The electrodes can be composed of any conductive metal but this embodiment uses nickel electrodes. The electrode thickness in this embodiment is 10 μm. The minimum thickness of the electrodes at about 0.5 μm is set by resistance and mechanical ruggedness criteria. At excessive thicknesses the differential expansion rates can cause separation or delamination of the electrode from the glass. The electrodes 13 are applied to the glass via bonding, plating, or coating methods that result in an intimate contact, preferably without voids. The glass tube 14 has a diameter of 1.2 cm and a length of 75 cm. Other lengths are possible depending on the UV power requirement of the lamp. The tube is filled with low-pressure neon at a pressure of about 5 Torr and <0.1% mercury by gas volume at the lamp operating temperature. The glass tube 14 is composed of UV-transmissive glass such as but not limited to Suprasil™. Electrical energy is delivered to the discharge 15 via capacitive coupling from the two electrodes 13 and the glass tube 14. Voltage may be applied to the electrodes via spring clips 16, or any other method known or later developed. Oscillating voltage applied between the electrodes 13 may be continuous or gated. A glow discharge 15 is established when the applied voltage reaches a value of about 5 kV peak-to-peak and the discharge extends inside the glass tube 14 between the locations of the two electrodes 13.

The overall electrical behavior (voltage, current, and power) of the source configuration of FIG. 3 can vary with the glass tube length and diameter, gas fill pressure, frequency, and intimacy of the electrode contact with the glass. As observed in the second embodiment, an applied voltage of 5 kV (peak-to-peak) having a frequency of 150 kHz delivered a peak electrical power of >200 W to a UV source, or lamp, in the discharge tube configuration having the dimensions described. The efficiency of coupling electrical energy to UV varies on the gas fill details. For the conditions typically found in a low-pressure (5 Torr) mixture of neon (99.9%) and mercury (0.1%), the UV output was observed to be>100 W primarily in UV-C photons having a wavelengths of 254 nm, 194 nm and 185 nm.

Modification of the Ultraviolet Radiation Output

The composition and intensity of the UV output of the system can be modified by varying the operation parameters. Desired output configuration for a given application requires tuning all of the parameters described below.

1. Modifying UV Output by Varying the Magnitude of the Applied Voltage

Increasing the magnitude of the driving voltage increases the power delivered to the UV source. An initial input of approximately 3 kV to 10 kV is typically required to initiate an electrical discharge. The magnitude of this voltage is dependent on many parameters such as, but not limited to, lamp geometry or size, fill-gas pressure, type of fill gases, or the frequency of the applied voltage. Once the discharge has started, it may be sustained using somewhat lower voltages, if desired. The resulting UV spectrum also can be modified by changing the gas type and fill pressure. There may be a minimum threshold in the applied voltage needed to generate a particular wavelength of UV for any given gas fill type and pressure.

2. Modifying UV Output by Varying the Tube Size or Geometry

The dimensions of the UV source can impact the UV output. For example, the inner and outer tube diameters and lengths of the embodiment shown in FIGS. 2 can be varied. By increasing the annular spacing between the tubes, the required operational voltage is increased. The higher voltage results in higher energy electrons in the discharge that excite the atoms in the fill gas to radiate shorter wavelength photons.

Different UV-radiating atomic transitions in the fill gas can have thresholds requiring voltages to exceed those thresholds to excite the desired transitions.

The total power delivered by a given UV source can be further affected by UV source size and geometry. For example, the length of the embodiments described in FIGS. 2 and 3 impacts the total power generated by the UV source. The UV output power was seen to scale linearly with the length of the source.

3. Modifying UV Output by Gas Fill Pressure

Like the tube dimensions, the gas fill pressure of the UV source can impact the UV output. For example, the gas pressure of the gas in the annular space created between the inner and outer tubes of the embodiment shown in FIG. 2 can be varied. By increasing the gas pressure, the required minimum operational voltage to create discharges is increased. Higher voltage results in higher energy electrons in the discharge that excite the atoms in the fill gas to radiate shorter wavelength photons. The higher gas pressure also increases the radiative cooling and electron collisions in the plasma, countering the impact of the higher applied voltage and changing the spectral shape of the UV emission of the UV source.

The total power delivered by a given UV source can also be affected by gas fill pressure. For example, the gas fill pressure of the embodiment described in FIG. 2 directly impacts the total power generated by the UV source. The output power for a given voltage is observed to decrease as the gas pressure is increased. This may be due to increased resistance in the gas.

4. Modifying UV Output by Varying the Driver Frequency and Pulse Shape

The issue of the frequency of the applied voltage is one of the largest variables in UV lamps in which capacitive coupling is employed. Low frequencies are known to be ineffective in capacitively coupled systems. As the frequency of the electrical driver is increased, the threshold operating voltage for any lamp configuration is observed to decrease as the UV. This can be advantageous in some instances but can result in significant lamp redesign if certain voltage thresholds are crossed. For DBD lamps of the configuration shown in FIG. 2, higher electrical driver frequencies result in a significant increase in the number of discharges per square centimeter between the glass tubes and a resultant higher UV power output but with a reduction in the threshold operating voltage. In order to maintain the same UV spectrum (minimum operating voltage) it may be necessary to increase the gas fill pressure or the spacing between the inner and outer tubes. Both of these changes increase the threshold operating voltage of the lamp.

Higher frequencies can impact the UV spectrum of UV lamps. For example, in the embodiment described in FIG. 2 higher frequencies result in higher rates of change of the applied voltage and produce increased UV production efficiency.

Lamp Lifetime

The typical feature that limits the lifetime of most UV lamps is electrode erosion. The concepts described herein of capacitively coupled energy via external electrodes virtually eliminate electrode erosion as a reason for decreased lamp lifetime.

The lifetime of UV sources based on the concepts in this application have been observed to be limited primarily by solarization of the glass envelope and can be expected to be greater than 5000-20,000 hours if a solarization-resistant glass such as Suprasil™ is used, further depending on the UV intensity and UV wavelength of the lamp output.

Lamp Power

Electrode erosion is the limiting factor when increasing the intensity of a UV source.

Higher UV powers require higher driving currents and result in greatly increased electrode erosion and shorter lamp lifetime. The concepts described herein of capacitively coupled energy via external electrodes virtually or substantially eliminate electrode erosion. Thus, high electrical powers can be delivered to such UV sources substantially without regard to electrode erosion. The limiting factor then becomes the heat dissipation from the lamp and the shortened lifetime due to rapid solarization at higher UV intensity output. For applications that require higher UV power output, externally mounted electrodes based on the designs included herein provide a real option to existing UV lamps.

1. An efficient, intense ultraviolet radiation source comprising:
electrodes that are intimately affixed externally to a glass envelope of a UV source to minimize or eliminate resistive and capacitive coupling losses and to eliminate electrode erosion;
a glass envelope, partly or wholly transmissive to ultraviolet radiation containing a desired gas; and
electrical energy in the form of alternating, high-frequency electric fields that is coupled efficiently into the fill gas of the UV source;
wherein the gas contained in the envelope is transformed into a hot, UV-emitting plasma that has no contact with any metallic components.

2. The ultraviolet source of claim 1, wherein the fill gas consists of hydrogen, deuterium, helium, neon, argon, krypton, xenon, bromine, chlorine, iodine, or mercury, or mixtures thereof.

3. The ultraviolet source of claim 1, wherein the geometry and design of the UV source is a dielectric barrier discharge (DBD).

4. The ultraviolet source of claim 3, wherein the inner electrode is solid.

5. The ultraviolet source of claim 3, wherein the inner electrode is cooled by forced air flow.

6. The ultraviolet source of claim 3, wherein the applied voltage is between 3 kV and 15 kV.

7. The ultraviolet source of claim 3, wherein the frequency of the applied voltage is between 25 kHz and 2 MHz.

8. The ultraviolet source of claim 1, wherein the geometry and design of the UV source is a low-pressure discharge tube.

9. The ultraviolet source of claim 8, wherein the applied voltage is between 3 kV and 15 kV.

10. The ultraviolet source of claim 8, wherein the frequency of the applied voltage is between 25 kHz and 2 MHz.

11. The intense ultraviolet source of claim 1, wherein the electrical input comprises a pulsed or gated high-frequency voltage.

12. A method for creating an efficient ultraviolet source comprising:
attaching electrodes externally to the glass envelope; and
coupling high-frequency electrical energy though the gas envelope;
wherein the contained gas inside the envelope between two electrodes is efficiently heated and ionized by the electrical driver.

13. The method of claim 12, wherein the electrical input comprises a pulse or gated high-frequency voltage.
